(19) United States
(12) Patent Application Publication
(10) Pub. No.: US 2022/0131707 A1
(43) Pub. Date: Apr. 28, 2022

(54) Digital Signature Method, Signature Information Verification Method, Related Apparatus and Electronic Device

(71) Applicant: Beijing Baidu Netcom Science Technology Co., Ltd., Beijing (CN)

(72) Inventors: Yuao CHEN, Beijing (CN); Runyao DUAN, Beijing (CN); Lijing JIN, Beijing (CN)

(21) Appl. No.: 17/570,971

(22) Filed: Jan. 7, 2022

(30) Foreign Application Priority Data
Mar. 25, 2021 (CN) 202110319789.7

(51) Int. Cl. H04L 9/32

(52) U.S. Cl. CPC H04L 9/3247; H04L 9/3239

(57) ABSTRACT

A digital signature method, a signature information verification method, a related apparatus and an electronic device are provided. The digital signature method includes: obtaining a to-be-sent file and a private key used by a first electronic device for digital signature, the private key including a first invertible matrix; generating L second tensors based on the first invertible matrix and a first tensor, the L second tensors including the first tensor and a tensor isomorphic to the first tensor; digitally signing the to-be-sent file based on a second invertible matrix and the first tensor, to obtain a first character string; constructing a hash value of a root node of a hash tree based on the L second tensors; generating signature information of the to-be-sent file based on the first character string, the first invertible matrix, the second invertible matrix, the L second tensors and the hash value of the root node.

### CROSS-REFERENCE TO RELATED APPLICATION

The present application claims priority to Chinese patent application No. 202110319789.7 filed in China on Mar. 25, 2021, the disclosure of which is incorporated in its entirety by reference herein.

### TECHNICAL FIELD

The present application relates to the field of quantum computing technologies, and in particular to the field of information security in quantum computing, and specifically to a digital signature method, a signature information verification method, a related apparatus and an electronic device.

### BACKGROUND

Digital signature is a basic public key cryptography task. Public key cryptography refers to that a cryptographic scheme includes a public key and a private key, and the public key may be made public so that two users may perform encryption, decryption and identity authentication without establishing communication therebetween. A purpose of digital signature is to authenticate the sender of a file, thus ensuring that the sender of the file is authentic, which is of fundamental importance in electronic commerce and Internet protocols.

Conventionally, digital signature schemes commonly used in Internet communications are based on hardness of large number factorization and discrete logarithms, such as asymmetric encryption algorithms based on Diffie-Hellman key exchange.

### SUMMARY

The present disclosure provides a digital signature method, a signature information verification method, a related apparatus and an electronic device.

According to a first aspect of the present disclosure, a digital signature method is provided, and the method is applied to a first electronic device and includes: obtaining a to-be-sent file and a private key used by the first electronic device for digital signature, where the private key includes a first invertible matrix; generating L second tensors based on the first invertible matrix and a randomly generated first tensor, where the L second tensors includes the first tensor and a tensor isomorphic to the first tensor, L is a positive integer greater than 1; digitally signing the to-be-sent file based on a randomly generated second invertible matrix and the first tensor, to obtain a first character string; constructing a hash value of a root node of a hash tree based on the L second tensors; generating signature information provided by the first electronic device for the to-be-sent file based on the first character string, the first invertible matrix, the second invertible matrix, the L second tensors and the hash value of the root node of the hash tree.

According to a second aspect of the present disclosure, a signature information verification method is provided, and the method is applied to a second electronic device and includes: obtaining a to-be-sent file, signature information of the to-be-sent file and a public key used by the second electronic device for verifying the signature information, where the public key corresponds to a private key associated with the signature information, the public key includes a hash value of a root node of a hash tree; generating Q second target character strings based on the signature information, where Q is a positive integer; generating a fourth tensor based on the signature information in a case that the hash value of the root node of the hash tree is equal to each of the second target character strings; digitally signing the to-be-sent file based on the fourth tensor, to obtain a second character string; verifying the signature information based on the second character string.

According to a third aspect of the present disclosure, a digital signature apparatus is provided, and the apparatus is applied to a first electronic device and includes: a first obtaining module, configured to obtain a to-be-sent file and a private key used by the first electronic device for digital signature, where the private key includes a first invertible matrix; a first generation module, configured to generate L second tensors based on the first invertible matrix and a randomly generated first tensor, where the L second tensors includes the first tensor and a tensor isomorphic to the first tensor, L is a positive integer greater than 1; a first digital signature module, configured to digitally sign the to-be-sent file based on a randomly generated second invertible matrix and the first tensor, to obtain a first character string; a construction module, configured to construct a hash value of a root node of a hash tree based on the L second tensors; a second generation module, configured to generate signature information provided by the first electronic device for the to-be-sent file based on the first character string, the first invertible matrix, the second invertible matrix, the L second tensors and the hash value of the root node of the hash tree.

According to a fourth aspect of the present disclosure, a signature information verification apparatus is provided, and the apparatus is applied to a second electronic device and includes: a second obtaining module, configured to obtain a to-be-sent file, signature information of the to-be-sent file and a public key used by the second electronic device for verifying the signature information, where the public key corresponds to a private key associated with the signature information, the public key includes a hash value of a root node of a hash tree; a fourth generation module, configured to generate Q second target character strings based on the signature information, where Q is a positive integer; a fifth generation module, configured to generate a fourth tensor based on the signature information in a case that the hash value of the root node of the hash tree is equal to each of the second target character strings; a second digital signature module, configured to digitally sign the to-be-sent file based on the fourth tensor, to obtain a second character string; a verification module, configured to verify the signature information based on the second character string.

According to a fifth aspect of the present disclosure, an electronic device is provided, and the electronic device includes: at least one processor; and a memory communicatively connected to the at least one processor, where, the memory stores therein an instruction executable by the at least one processor, and the instruction, when executed by the at least one processor, causes the at least one processor to implement any method in the first aspect or any method in the second aspect.

According to a sixth aspect, a non-transitory computer-readable storage medium storing therein computer instructions is provided, where the computer instructions are used for causing a computer to implement any method in the first aspect or any method in the second aspect.

According to a seventh aspect of the present disclosure, a computer program product is provided, where the computer program product, when being executed by an electronic device, causes the electronic device to implement any method in the first aspect or any method in the second aspect.

It is understood, this summary is not intended to identify key features or essential features of the embodiments of the present disclosure, nor is it intended to be used to limit the scope of the present disclosure. Other features of the present disclosure will become more comprehensible with reference to the following description.

### BRIEF DESCRIPTION OF THE DRAWINGS

The drawings are used to better understand the solutions of the present application and constitute no limitation on the present application.

FIG. 1 is a schematic flowchart of a digital signature method according to a first embodiment of the present application;

FIG. 2 is a schematic diagram of implementation of a computation of an authentication path of a target tensor relative to a root node of a hash tree;

FIG. 3 is a schematic flowchart of a signature information verification method according to a second embodiment of the present application;

FIG. 4 is a schematic structural diagram of a digital signature apparatus according to a third embodiment of the present application;

FIG. 5 is a schematic structural diagram of a signature information verification apparatus according to a fourth embodiment of the present application;

FIG. 6 is a schematic block diagram of an exemplary electronic device 600 for implementing embodiments of the present disclosure.

### DETAILED DESCRIPTION

In the following description, numerous details of the embodiments of the present application, which should be deemed merely as exemplary, are set forth with reference to accompanying drawings to provide thorough understanding of the embodiments of the present application. Therefore, those skilled in the art will appreciate that modifications and replacements may be made in the described embodiments without departing from the scope and the spirit of the present application. Further, for clarity and conciseness, descriptions of known functions and structures are omitted hereinafter.

### First Embodiment

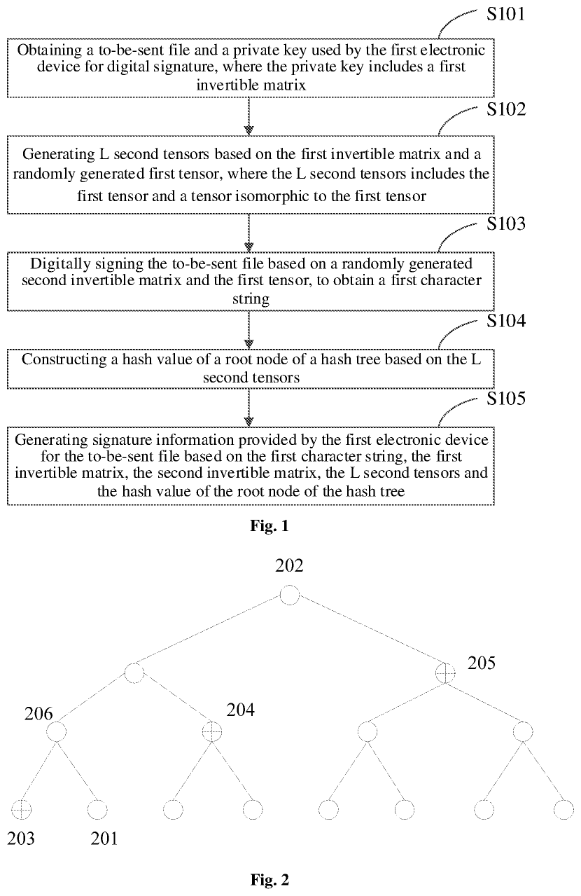

As shown in FIG. 1, the present application provides a digital signature method, and the method is applied to a first electronic device and includes following steps S101 to S105.

Step S101: obtaining a to-be-sent file and a private key used by the first electronic device for digital signature, where the private key includes a first invertible matrix.

In the embodiment, the digital signature method relates to the field of quantum computing technologies, specifically to the field of information security related to quantum computing. The method may be widely used in many scenarios such as e-commerce, identity authentication and software distribution.

For example, in an identity authentication scenario, it is assumed that a first party needs to send a file to a second party, and the second party needs to authenticate that the file is actually sent by the first party and not by someone else. At this point, the first party may digitally sign this file, and after receiving the file and corresponding signature information and obtaining a public key publicly broadcast by the first party, the second party may authenticate that the sender of this file is indeed the first party.

For another example, in a software distribution scenario, identity authentication of a publisher of an obtained software may be performed to determine the origin of the software.

In practice, the digital signature method according to the embodiment of the present application may be performed by a digital signature apparatus according to an embodiment of the present application. The digital signature apparatus may be configured in any first electronic device to perform the digital signature method according to the embodiment of the present application. The first electronic device may be a server or a terminal, which is not specifically limited herein.

The first electronic device, as a sender of communication, may communicate with other electronic devices to send files. In order to enable other electronic devices to authenticate that the received file is indeed sent by the first electronic device and to authenticate authenticity of the sender, the first electronic device may use a digital signature technique to digitally sign the to-be-sent file before sending the file.

The to-be-sent file refers to a file that the first electronic device needs to send to other electronic device, and the to-be-sent file may be of a type such as text, compressed package or audio/video.

The private key may be a parameter pre-stored by the first electronic device and used to encrypt and digitally sign the file to be sent from the first electronic device. The private key may correspond to a public key, and a combination of the private key and the public key may be called a key pair. The public key is usually published by the first electronic device to other electronic devices, so that the other electronic devices may use the public key to verify signature information provided by the first electronic device.

As a task in public key cryptography, digital signature schemes need to be based on hardness of a certain algorithmic problem to ensure the security of digital signature. With development of quantum computers, the algorithmic problems that the existing digital signature schemes are based on may not be hard for quantum computers. That is, the algorithmic problems on which the digital signature schemes are based may not be able to withstand quantum attacks, and thus the security of digital signature is threatened.

The hardness mentioned above is a subtle concept. Firstly, unlike generally considered the worst-case hardness, what is needed here is average-case hardness, i.e., there is no valid algorithm for most of inputs. Secondly, not all hard problems correspond to a suitable digital signature protocol, thus appropriate protocols also need to be designed based on the problems. Finally, there is also a need to explore usability of the problem in context of post-quantum cryptography from the perspective of quantum algorithm design; for example, although the large number factoring problem is hard from the perspective of a classical computer, the problem is easy from the perspective of quantum computing.

From the perspective of computational complexity, the tensor isomorphism problem may be regarded as a harder problem among isomorphism-type problems. From the perspective of quantum computing, due to hardness of solving the tensor isomorphism problem, security of digital signature designed by using the tensor isomorphism problem is guaranteed in the perspective of quantum algorithms Therefore, in the embodiment of the present application, the algorithmic problem that the digital signatures are based on may use the tensor isomorphism problem, that is, the hardness for most computers (including quantum computers) to solve the tensor isomorphism problem is used to design digital signatures.

The tensor isomorphism problem may be described as follows.

It is assumed that p is a prime number and GF(p) represents a modulo P field. GL(n, p) denotes a set of invertible matrices having a size of n×n in GF(p) A multi-order matrix in GF(p) may be called a tensor, where an order of the tensor is usually greater than 2.

As an example, if the tensor is a third-order matrix, the tensor may be called an n×n×n matrix with n×n×n components, and n may be called a dimension of the tensor. Assuming that a tensor is A represented by A=(aᵢⱼₖ), and another tensor is B represented by B=(bᵢⱼₖ), a length of each order of data is n, i.e., subscripts i, j and k of the tensor range from 1 to n, respectively, represented by i, j, k∈{1, 2, . . . , n} , and aᵢⱼₖ,bᵢⱼₖ∈GF(p) are elements of the i-th sheet, j-th row and k-th column of the two tensors, respectively, and these elements can be enumerated to form the tensors, that is, (aᵢⱼₖ) and (bᵢⱼₖ). The tensor isomorphism problem is to solve whether there exists an invertible matrix, represented by C=(cᵢⱼ)∈GL(n, p), such that A=(C, C, C) ^{∘}B. In other words, the tensor isomorphism problem is to determine whether two tensors are isomorphic to each other and in the case that the two tensors are isomorphic to each other, find the invertible matrix of the mutual transformation of the two tensors.

The “^{∘}” in the formula (C, C, C)^{∘}B indicates that the tensor are multiplied by three matrices in three directions of the tensor respectively, that is, three matrices may be multiplied in the three directions of the tensor at the same time, three matrices may be the same invertible matrix C. A multiplication result thereof is also a tensor, which may be represented by B′, where B′=(b′ᵢⱼₖ), and b′ᵢⱼₖ is a number at the position corresponding to the subscripts in the tensor B′, b′ᵢⱼₖ=Σₒ₌₁ⁿcᵢₒ(Σ_{q=1}ⁿcₖᵥb_{oqv}))=Σ_{oqv}cᵢₒc_{jq}cₖᵥb_{oqv}.

It should be noted that, in a case that the tensor is a higher-order matrix, the tensor isomorphism problem may also be extended to a tensor which is a higher-order matrix, i.e., the tensor isomorphism problem of the higher-order matrix can be analogized based on the tensor isomorphism problem of the third-order matrix. For example, for two tensors that are fourth-order matrices, which may be represented by A=(aᵢⱼₖₗ)and B=(bᵢⱼₖₗ) respectively, the tensor isomorphism problem refers to whether there exists an invertible matrix C such that A=(C, C, C, C)^{∘}B.

In the premise of the tensor isomorphism problem, since it is hard to solve an invertible matrix of a transformation between the two tensors even if the two tensors are known to be isomorphic. Therefore, in order to ensure the security of digital signature, the private key used by the first electronic device for the digital signature may be set in a form of a matrix to ensure hardness of cracking the private key.

Specifically, the private key may include a first invertible matrix, the public key may be set in tensor form or may be set as a character string transformed from a tensor (the character string may be a hash value set based on the tensor), and the public key is published. Thus, if other electronic devices need to forge the signature information provided by the first electronic device for the to-be-sent file, they need to crack the private key based on the public key, which is equivalent to that other electronic devices need to solve a tensor isomorphism problem. Due to the hardness of solving the tensor isomorphism problem, it is hard for other electronic devices to crack the private key of the first electronic device based on the public key, so it is hard for other electronic devices to forge the signature provided by the first electronic device, thus ensuring the security of the digital signature.

In practical applications, an identity authentication protocol may be constructed based on the tensor isomorphism problem by using a zero-knowledge interactive protocol for the classical graph isomorphism problem. Depending on the required security, this protocol may be carried out several rounds and multiple tensors are generated in each round. Based on this identity authentication protocol, a digital signature scheme may be constructed by using a transformation process of the classical identity identification protocol Fiat-Shamir.

In the digital signature scheme, important parameters may include a signature length, a public key length, and a runtime for generating a key, generating a signature, and verifying the signature. According to main parameters (e.g., n is the number of dimensions of a tensor, i.e., a scale of the tensor, p is a size of a field, i.e., a scale of number field, r is the number of rounds, i.e., a signature length parameter, λ is a security parameter, and s is a hash tree depth, let t=2^{s}, which is the number of leaf nodes of the hash tree and the number of tensors involved in generating the public key) in the protocol and the understanding of the best algorithm runtime for the tensor isomorphism problem, appropriate parameters may be selected to achieve the desired security of the digital signature, e.g., to achieve 128-bit or 256-bit security. At the same time, a prototype of the protocol may be implemented to test an actual runtime for generating a key, generating a signature and verifying the signature.

There may be various ways to obtain the to-be-sent file, for example, the to-be-sent file may be obtained from a pre-stored file, or, for example, the to-be-sent file may be actively generated.

The private key may be pre-generated by the first electronic device and stored in a database, or may be pre-set by a developer and stored in a database, which is not specifically limited herein.

Taking the private key pre-generated by the first electronic device and stored in the database as an example, the first electronic device may randomly generate at least one first invertible matrix, e.g., randomly generate t−1 first invertible matrices, represented by Cᵢ∈GL(n, p), i∈{1, 2, . . . , t−1}, where t may be set according to actual situation, and t is greater than or equal to 2. The private key of the first electronic device may include multiple invertible matrices, which may be C₀, C₁, . . . , Cₜ₋₁, respectively, where C₀ is a unit matrix of size n.

Step S102: generating L second tensors based on the first invertible matrix and a randomly generated first tensor, where the L second tensors includes the first tensor and a tensor isomorphic to the first tensor, L is a positive integer greater than 1.

Taking a case in which the tensor isomorphism problem using a third-order matrix is used for the design of a digital signature scheme as an example, when constructing the private key and the public key of the first electronic device, one first tensor may be randomly generated, which may be represented by A₀. The first tensor A₀=(aᵢⱼₖ), i, j, k∈{1, 2, . . . , n}, aᵢⱼₖ∈GF(p). This first tensor may be used as an initial tensor to generate an isomorphic tensor.

For i∈{1 , . . . , t−1}, the first electronic device may construct a tensor isomorphic to the first tensor based on the first invertible matrix in the private key and the first tensor. The tensor may be constructed with the formula Aᵢ=(Cᵢ, Cᵢ, Cᵢ)^{∘}A₀. Finally, L second tensors are obtained, and the L second tensors may include the first tensor and the tensor isomorphic to the first tensor.

In practical applications, a value of L may be t. The L second tensors may be sent to other electronic devices as a public key. Since the biggest problem of sending the L second tensors as the public key to other electronic devices is that a public key length is relatively large, and thus will greatly impact efficiency when applied in scenarios where the public key needs to be exchanged, a character string based on a transformation of the L second tensors may be sent to other devices as the public key, and the character string may also be a hash value which is set based on the tensor, which is explained in detail below, and is not specifically limited herein.

Step S103: digitally signing the to-be-sent file based on a randomly generated second invertible matrix and the first tensor, to obtain a first character string.

Based on the randomly generated second invertible matrix and the first tensor, a hash function may be used to digitally sign the to-be-sent file to obtain the first character string.

Specifically, a third tensor isomorphic to the first tensor may be generated based on the randomly generated second invertible matrix and the first tensor; based on the third tensor, the to-be-sent file is digitally signed to obtain the first character string.

In practical applications, for i∈{1, . . . , r}, r may be a positive integer, the first electronic device may randomly generate at least one second invertible matrix, and the at least one second invertible matrix may be represented by Dᵢ∈GL(n, p). That is, at least one third tensor that is isomorphic to the first tensor may be constructed based on the randomly generated second invertible matrix and the first tensor. A construction formula may be Bᵢ=(Dᵢ, Dᵢ, Dᵢ)^{∘}A₀, i∈{1, . . . , r}.

Next, a hash function (represented by H) may be used to digitally sign the to-be-sent file (represented by M). Specifically, the to-be-sent file M may be concatenated with the third tensors B₁, . . . , Bᵣ as a character string, and a hash operation may be performed on the concatenated character string to obtain the first character string, represented by H(M|B₁| . . . |Bᵣ).

M|B₁| . . . . |Bᵣrepresents the character string as a result of concatenation of the to-be-sent file M and the third tensors B₁, . . . , Bᵣ, the first character string may be a binary character string, i.e., a character string of characters ‘0’ and ‘1’, whose length may be r*s, and the parameter s is also a parameter of an identity authentication protocol, where parameters s and t satisfies t=2^{s}. H is a hash function, an input to H may be a character string of any length, while a character string output by H is of length r*s, and H outputs the character string of characters ‘0’ and ‘1’.

Step S104: constructing a hash value of a root node of a hash tree based on the L second tensors.

In this step, in cryptography and computer science, a hash tree is a tree data structure which may include multiple layers, where each layer includes at least one node, each node is labeled with a hash of a data block, while a node other than leaf nodes is labeled with a cryptographic hash of its child node's label.

The hash value of the root node of the hash tree may be constructed by using a hash function based on the L second tensors, and the hash tree may be constructed either directly based on the L second tensors or based on the L second tensors and a randomly generated first target character string.

Taking constructing the hash tree based on the L second tensors and the randomly generated first target character string as an example, specifically, the first target character string, which may be represented by MerkleKey, may be randomly generated. Specifically, the MerkleKey may be generated based on a random function such as uniform or random.

The MerkleKey may be a character string of characters ‘0’ and ‘1’ with a length λ, and λ may be a security parameter. That is, λ may be set according to the security required for digital signature, e.g., λ may be set to 128 if the digital signature needs to achieve 128-bit security.

A leaf node of the hash tree may be constructed based on the L second tensors. Specifically, a hash function H may be used to construct the s-th layer of the hash tree, i.e., a layer corresponding to the leaf node. The construction is represented by the formula h_{s,i}=H(Aᵢ|(2^{s}+i)|MerkleKey), where 0≤i≤t−1, h_{s,i} is a hash value of the i-th leaf node at a layer corresponding to the leaf node, i.e., the s-th layer, and the symbol I indicates concatenation of character strings.

The other internal nodes of the hash tree are continued to be constructed by using the hash function H. The construction is represent by a formula h_{k,i}=H(h_{k+1,2i}|h_{k+1,2i+1}|(2^{k}+i)|MerkleKey), where 0≤k<s, 0≤i<2^{k}, h_{k,i} is a hash value of the i-th node at the k-th layer, h_{k+1,2i} and h_{k+1,2i+1} are hash values of two child nodes of the i-th node, respectively, the i-th node may be called the parent node of these two child nodes. Thereby, all elements of the hash tree may be constructed, including the root node of the hash tree, represented by h_{0,0} , and a hash value of h_{0,0} may be used as a part of the public key.

Step S105: generating signature information provided by the first electronic device for the to-be-sent file based on the first character string, the first invertible matrix, the second invertible matrix, the L second tensors and the hash value of the root node of the hash tree.

The signature information may include a first character string, a target matrix generated from the first character string, the first invertible matrix and the second invertible matrix, N second tensors selected from the L second tensors based on the first character string, and an authentication path of each second tensor of the N second tensors relative to the root node of the hash tree, where the authentication path is determined based on the second tensor and the hash value of the root node of the hash tree. The authentication path of the second tensor relative to the root node of the hash tree includes a series of hash values, i.e., all information required for calculating, from the second tensor, the hash values of nodes, up until the root node of the hash tree.

In an optional implementation, the signature information may include multiple character strings segmented from the first character string, a target matrix generated from the multiple character strings, the first invertible matrix and the second invertible matrix, N second tensors, and an authentication path of each second tensor of the N second tensors relative to the root node of the hash tree.

In this embodiment, the to-be-sent file and the private key used by the first electronic device for digital signature are obtained, where the private key includes a first invertible matrix; L second tensors are generated based on the first invertible matrix and the randomly generated first tensor, where the L second tensors includes the first tensor and the tensor isomorphic to the first tensor; the to-be-sent file is digitally signed based on the randomly generated second invertible matrix and the first tensor, to obtain the first character string; the hash value of the root node of the hash tree is constructed based on the L second tensors; signature information provided by the first electronic device for the to-be-sent file is generated based on the first character string, the first invertible matrix, the second invertible matrix, the L second tensors and the hash value of the root node of the hash tree. In this way, the digital signature is achieved based on the tensor isomorphism problem combined with the hash tree. If other electronic devices need to forge the signature information provided by the first electronic device for the to-be-sent file, the other electronic devices need to crack the private key based on the public key (which may include the isomorphic tensors or the hash values generated based on the isomorphic tensors), which is equivalent to a situation that other electronic devices need to solve a hash tree decryption problem and a tensor isomorphism problem. Thus it is very hard for other devices to forge the private key based on the public key without knowing the private key, thus making it very hard to forge digital signature, which in turn may improve security of digital signature.

Optionally, the step S105 specifically includes: segmenting the first character string to obtain P character strings, where P is a positive integer greater than 1; generating a target matrix based on the P character strings, the first invertible matrix and the second invertible matrix; selecting, based on the P character strings, N second tensors from the L second tensors, where N is a positive integer; for each second tensor of the N second tensors, determining an authentication path of the second tensor relative to the root node of the hash tree based on the hash value of the root node of the hash tree and the second tensor; where, the signature information includes the P character strings, the target matrix, the N second tensors, and the authentication path of each second tensor of the N second tensors relative to the root node of the hash tree.

In this implementation, the first character string may be segmented to obtain multiple character strings, for example, to obtain a number r of character strings of characters ‘0’ and ‘1’, each of a length s, where the r character strings may be represented by f₁, . . . fᵣ respectively, in this case, r is greater than 1, decimal values of the r character strings are all between 0 and t−1 and a value of P is equal to r.

A target matrix may be generated based on the P character strings, the first invertible matrix and the second invertible matrix. Specifically, for i∈{1, . . . , r}, the first electronic device may use the formula Eᵢ=DᵢC_{f}_{ᵢ}⁻¹ to calculate the target matrix. Eᵢ is the target matrix, there may be plural target matrices, C_{f}_{ᵢ}⁻¹ represents an inverse matrix of the fᵢ-th invertible matrix in the private key. For example, when the character string of characters ‘0’ and ‘1’ fᵢ is 1, C_{f}_{ᵢ}⁻¹ is an inverse matrix of the invertible matrix C₁ in the private key. That is, the target matrix may be obtained based on matrix multiplication of the second invertible matrix Dᵢ and an inverse matrix of the invertible matrix C_{f}_{ᵢ} in the private key.

Next, N second tensors may be selected from the L second tensors based on the P character strings. Specifically, N second tensors may be selected from A₀, A₁, . . . , Aₜ₋₁, where the N second tensors are A_{f}_{ᵢ} , . . . , A_{f}_{ᵣ} respectively, and N is equal to r.

For i∈{1, . . . , r} an authentication path of the second tensor A_{f}_{ᵢ}, represented by pathᵢ, is calculated based on the second tensor A_{f}_{ᵢ} and the hash value of the root node of the hash tree. The pathᵢ includes a series of hash values, i.e., all information needed for calculating, from the second tensor A_{f}_{ᵢ}, the hash values of nodes, up until the root node of the hash tree.

That is, the pathᵢ calculated based on the second tensor A_{f}_{ᵢ} may make pathᵢ(A_{f}_{ᵢ})=h_{0.0}, where the above formula is a shorthand for a process of calculating from A_{f}_{ᵢ} up until h_{0.0} is obtained, and indicates that based on A_{f}_{ᵢ} and hash values in the authentication path, the hash function is called repeatedly until the hash value of the root node of the hash tree is obtained. In other words, the essence of the process is to travel through the hash tree according to the authentication path pathᵢ, such that a corresponding leaf node

$${h}_{s , {f}_{i}}$$

in the hash tree is obtained based on the second tensor A_{f}_{ᵢ}, and it is possible to travel from the leaf node

$${h}_{s , {f}_{i}}$$

to the root node h_{0,0} of the hash tree to obtain the hash value of the root node of the hash tree.

Finally, the signature information provided by the first electronic device for the to-be-sent file may be determined based on the r character strings, multiple target matrices, the N second tensors and the authentication path of each second tensor of the N second tensors relative to the root node of the hash tree. The signature information is f₁, . . . , fᵣ, E₁, . . . , Eᵣ, A_{f}_{₁}, . . . , A_{f}_{ᵣ}, path₁, . . . , pathᵣ).

If another electronic device such as a third electronic device wishes to disguise itself as the first electronic device and wishes to generate a signature for the to-be-sent file M, since the third electronic device does not have the private key, the third electronic device may not generate the target matrix based on the private key, i.e., the third electronic device cannot use the formula Eᵢ=DᵢC_{f}_{ᵢ}⁻¹ to generate the target matrices E₁, . . . , Eᵣ. Since cracking the private key requires solving a tensor isomorphism problem, it is hard for the third electronic device to obtain the private key of the first electronic device. At the same time, since the public key obtained by the third electronic device is generated based on the isomorphic tensor in conjunction with the hash tree, the public key includes the hash value of the root node of the hash tree. In this way, if the third electronic device wishes to forge the signature, the third electronic device has to crack the hash tree. Considering the hardness of designing a preimage of the hash function, it is very hard for the third electronic device to forge the signature information.

Furthermore, direct attack methods of the third electronic device against the protocol all boil down to such a problem: the third electronic device needs to find a way to generate multiple character strings of characters ‘0’ and ‘1’, i.e., g₁, . . . , gᵣ ∈{0, 1, . . . , t−1}, such that after calculating Bᵢ=(Dᵢ, Dᵢ, Dᵢ)^{∘}A_{g}_{ᵢ}, i∈{1, . . . , r}, for all i∈{1, . . . , r} the f₁, . . . fᵣ obtained from the calculation of H(M|B₁| . . . |Bᵣ) satisfy f=gᵢ. However, according to the nature of hash function, the success probability of such an attack will not significantly exceed ½^{rs}.

Therefore, based on the above two points, it is very hard for the third electronic device to forge the signature information provided by the first electronic device.

Further, combinations of parameters in the protocol may be set as follows to achieve 128-bit security, as shown in table 1 below.

TABLE 1
some combinations of parameters for achieving 128-bit security

| | | | | | Public key length | Signature length |
|---|---|---|---|---|---|---|
| | n | p | r | s | (Bytes) | (Bytes) |
| Combination 1 | 9 | 8191 | 128 | 1 | 32 | 1352064 |
| Combination 2 | 9 | 8191 | 16 | 8 | 32 | 21588 |
| Combination 3 | 9 | 8191 | 10 | 12 | 32 | 13658 |

In this embodiment, the first character string is segmented to obtain the P character strings; the target matrix is generated based on the P character strings, the first invertible matrix and the second invertible matrix; based on the P character strings, the N second tensors are selected from the L second tensors; for each second tensor of the N second tensors, the authentication path of the second tensor relative to the root node of the hash tree is determined based on the hash value of the root node of the hash tree and the second tensor; where, the signature information includes the P character strings, the target matrix, the N second tensors, and the authentication path of each second tensor of the N second tensors relative to the root node of the hash tree. In this way, in the case that other electronic devices do not know the private key, it is very hard to forge the invertible matrix, i.e., forge the private key, from the public key generated based on the tensor isomorphism problem combined with the hash tree. At the same time, it is also very hard to crack the hash tree based on the root node of the hash tree, thus it is very hard to forge digital signature, which in turn may improve security of digital signature.

Optionally, the N second tensors include a target tensor, the target tensor is any one tensor of the N second tensors. For each second tensor of the N second tensors, determining the authentication path of the second tensor relative to the root node of the hash tree based on the hash value of the root node of the hash tree and the second tensor includes: determining, based on a hash value of a leaf node corresponding to the target tensor of the hash tree and the hash value of the root node of the hash tree, a target hash value of a node on a path from the leaf node corresponding to the target tensor to the root node of the hash tree.

The authentication path of the target tensor relative to the root node of the hash tree includes: the target hash value, and a position in the hash tree of the node on the path from the leaf node corresponding to the target tensor to the root node of the hash tree.

This implementation specifically describes the authentication path of the target tensor relative to the root node of the hash tree. When constructing the hash tree, each node of the hash tree stores a value of the hash function, i.e., a hash value, for example, the hash value stored by a node A is and only is a function of hash values of two child nodes below the node A, a position of the node A and the first target character string MerkleKey. Therefore, as long as the hash values of the two child nodes, the position of the node A and the MerkleKey are known, the hash value stored by the node A may be computed by using the hash function H. The authentication path is all information needed for calculating traveled nodes, so that the hash value of the root node may be calculated. It should be noted that, the hash function used for the signature process of the first electronic device and the hash function used for the signature verification process of the second electronic device should be uniform.

Referring to FIG. 2, FIG. 2 is a schematic diagram of implementation of a computation of an authentication path of a target tensor relative to a root node of a hash tree. As shown in FIG. 2, firstly, based on the target tensor, the hash function is called to determine a hash value of a leaf node 201 in a hash tree that corresponds to a target tensor. A leaf node 203, a node 204 and a node 205 are traveled when traveling from the leaf node 201 to a root node 202.

The difference between the traveled nodes when traveling from leaf node 201 to the root node 202 and other nodes in the hash tree, such as a node 206, is that: the node 206 may be calculated based on the hash values of the leaf node 201 and the leaf node 203, while for the traveled nodes, it is necessary to obtain hash values of the nodes in the hash tree based on their positions. The hash values of the traveled nodes may be used in combination with the target tensor to calculate the hash value of the root node of the hash tree.

In a case that the hash value of the leaf node 201 is obtained, a position as well as a hash value of the leaf node 203 may be obtained. For example, the leaf node 203 is to the left of the leaf node 201, accordingly the hash value of the leaf node 203 that is to the left of the neighboring leaf node 201 is obtained, and the authentication path of the target tensor relative to the root node of the hash tree includes the position and the hash value of the leaf node 203.

Next, based on the hash value of the leaf node 201 and the hash value of the leaf node 203, a hash value of their parent node may be obtained by calling the hash function. Accordingly, a traveled node including the node 204 to the right of their parent node may be obtained. Accordingly, the hash value of the node 204 at that position in the hash tree may be obtained, and the authentication path of the target tensor relative to the root node of the hash tree includes a position and a hash value of the node 204.

The hash value of the node 205 is obtained in a similar way to the hash value of the node 204, so it will not be described again. Finally, a hash value may be calculated based on a hash value of a parent node of the node 204 and the hash value of the node 205, so that the calculated hash value is equal to the hash value of the root node of the hash tree, and the authentication path of the target tensor relative to the root node of the hash tree includes the position and the hash value of the node 203, the position and the hash value of the node 204, and a position and a hash value of the node 205.

In the implementation, based on the hash value of the leaf node corresponding to the target tensor of the hash tree and the hash value of the root node of the hash tree, the target hash value of the traveled node on the path from the leaf node corresponding to the target tensor to the root node of the hash tree is determined, so that the authentication path of the target tensor relative to the root node of the hash tree may be obtained, and then the digital signature provided by the first electronic device may be implemented based on the authentication path.

Optionally, the step S103 specifically includes: generating a third tensor isomorphic to the first tensor based on the randomly generated second invertible matrix and the first tensor; digitally signing the to-be-sent file based on the third tensor, to obtain the first character string.

In the implementation, for i∈{1, . . . , r}, r may be a positive integer, the first electronic device may randomly generate at least one second invertible matrix, and the at least one second invertible matrix may be represented by Dᵢ∈GL(n, p). That is, at least one third tensor that is isomorphic to the first tensor may be constructed based on the randomly generated second invertible matrix and the first tensor, and a construction formula may be Bᵢ=(Dᵢ, Dᵢ, Dᵢ)^{∘}A₀, i∈{1, . . . , r}.

Next, a hash function (represented by H) may be used to digitally sign the to-be-sent file (represented by M). Specifically, the to-be-sent file M may be concatenated with the third tensors B₁, . . . , Bᵣ as a character string, and a hash operation may be performed on the concatenated character string to obtain the first character string, represented by H(M|B₁| . . . |Bᵣ).

M|B₁| . . . |Bᵣ represents the character string as a result of concatenation of the to-be-sent file M and the third tensors B₁, . . . , Bᵣ, the first character string may be a binary character string, i.e., a character string of characters ‘0’ and ‘1’, whose length may be r*s, and the parameter s is also a parameter of an identity authentication protocol, where parameters s and t satisfies t=2^{s}. H is a hash function, an input to H may be a character string of any length, while a character string output by H is of length r*s, and H outputs the character string of characters ‘0’ and ‘1’.

In the implementation, the third tensor isomorphic to the first tensor is generated based on the randomly generated second invertible matrix and the first tensor; based on the third tensor, the to-be-sent file is digitally signed to obtain the first character string, so that the digital signature may be implemented.

Optionally, the step S104 specifically includes: constructing a hash value of a leaf node of the hash tree based on the L second tensors and a randomly generated first target character string; constructing a hash value of another node of the hash tree other than the leaf node based on the hash value of the leaf node of the hash tree and the first target character string, where the another node includes the root node of the hash tree.

This implementation describes a specific process for constructing a hash tree based on the L second tensors and the randomly generated first target character string.

The first target character string may be randomly generated, and may be represented by MerkleKey. Specifically, the MerkleKey may be generated based on a random function such as uniform or random.

The MerkleKey may be a character string of characters ‘0’ and ‘1’ with a length λ, and λ may be a security parameter. That is, λ may be set according to the security required for digital signature, e.g., 2 may be set to 128 if the digital signature needs to achieve 128-bit security.

A leaf node of the hash tree may be constructed based on the L second tensors. Specifically, a hash function H may be used to construct the s-th layer of the hash tree, i.e., a layer corresponding to the leaf node. The construction is represented by the formula h_{s,i}=H(Aᵢ|(2^{s}+i)|MerkleKey), where 0≤i≤t−1, h_{s,i} is a hash value of the i-th leaf node at a layer corresponding to the leaf node, i.e., the s-th layer, and the symbol | indicates concatenation of character strings.

The other internal nodes of the hash tree are continued to be constructed by using the hash function H. The construction is represent by a formula h_{k,i}=H(h_{k+1,2i}|h_{k+1,2i+1}|(2^{k}+i)|MerkleKey), where 0≤k<s, 0≤i<2^{k}, h_{k,i} is a hash value of the i-th node at the k-th layer, h_{k+1,2i} and h_{k+1,2i+1} are hash values of two child nodes of the i-th node, respectively, the i-th node may be called the parent node of these two child nodes. Thereby, all elements of the hash tree may be constructed, including the root node of the hash tree, represented by h_{0,0}, and a hash value of h_{0,0} may be used as a part of the public key.

In the implementation, the hash value of the root node of the hash tree is constructed based on the L second tensors and the randomly generated first target character string. Thus, hardness of cracking the hash tree may be improved, and the security of the digital signature may be further improved.

Optionally, prior to the step S101, the method further includes: generating a public key corresponding to the private key, where the public key includes the first target character string and the hash value of the root node of the hash tree; and publishing the public key.

This implementation is a process of generating the public key based on the private key. In order to enable other electronic devices to authenticate the sender of the to-be-sent file, i.e., the first electronic device, in a case that the other electronic devices receives the signature information and the to-be-sent file from the first electronic device, the public key corresponding to the private key needs to be published.

The private key includes a first invertible matrix Cᵢ∈GL(n, p),i∈{1, 2, . . . , t−1} and a unit matrix C₀ of size n. A tensor isomorphic to the first tensor may be generated based on the first invertible matrix and the first tensor, and finally the L second tensors are obtained, where L may be equal to t. The L second tensors may be represented by Aᵢ, i∈{0, . . . , t−1}.

The first target character string MerkleKey is randomly generated, and the hash value of the leaf node of the hash tree is constructed by using the hash function based on MerkleKey and the L second tensors. The construction process has been described in detail above and will not be repeated here. It should be noted that, the first target character string used for the signature process of the first electronic device and the first target character string used for the signature verification process of the second electronic device should be uniform.

Based on the hash value of the leaf node and the MerkleKey, the hash function is used continually to construct hash values of other nodes of the hash tree, and finally the hash value of the root node of the hash tree may be constructed. The public key corresponding to the private key includes the first target character string and the hash value of the root node of the hash tree.

Next, the generated public key may be published, and accordingly, other electronic devices may obtain the public key of the first electronic device.

In the implementation, the private key and a randomly generated initial tensor are used to construct a tensor isomorphic to this initial tensor, to obtain the L second tensors, and the hash value of the root node of the hash tree is constructed based on the L second tensors and the first target character string. The hash value of the root node of the hash tree and the first target character string are published as the public key of the first electronic device. In this way, the length of the public key may be greatly reduced, which may improve application efficiency in scenarios where the public key needs to be exchanged.

### Second Embodiment

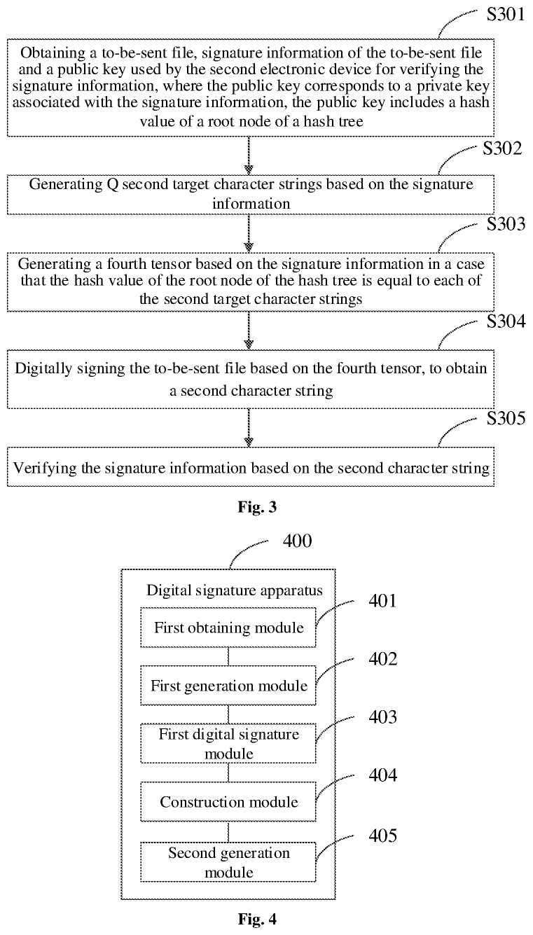

As shown in FIG. 3, the present application provides a signature information verification method, and the method is applied to a second electronic device and includes following steps S301 to S305.

Step S301: obtaining a to-be-sent file, signature information of the to-be-sent file and a public key used by the second electronic device for verifying the signature information, where the public key corresponds to a private key associated with the signature information, the public key includes a hash value of a root node of a hash tree.

Step S302: generating Q second target character strings based on the signature information, where Q is a positive integer.

Step S303: generating a fourth tensor based on the signature information in a case that the hash value of the root node of the hash tree is equal to each of the second target character strings.

Step S304: digitally signing the to-be-sent file based on the fourth tensor, to obtain a second character string.

Step S305: verifying the signature information based on the second character string.

In the embodiment, the second electronic device is an electronic device configured to receive the to-be-sent file, the first electronic device may send to the second electronic device the to-be-sent file and the signature information of the to-be-sent file, and correspondingly, the second electronic device may receive the to-be-sent file and the signature information of the to-be-sent file.

The first electronic device publishes the public key used to authenticate its identity before sending the to-be-sent file and the signature information of the to-be-sent file, and correspondingly, the second electronic device may obtain the public key published by the first electronic device.

The public key corresponds to the private key associated with the signature information, i.e., the public key and the private key used to generate the signature information are a key pair. The public key may include the hash value of the root node of the hash tree, and the public key may also include the first target character string.

The second electronic device may perform dual-verification on the signature information to ensure accuracy of the authentication.

A first verification may specifically include the following steps: generating Q second target character strings based on the signature information, Q is a positive integer, and comparing the hash value of the root node of the hash tree in the public key with each second target character string, and a second verification is performed only when the hash value is equal to each second target character string; otherwise, the verification fails if there exists a second target character string that is not equal to the hash value of the root node of the hash tree.

The second verification is initiated in a case that the hash value of the root node of the hash tree is equal to each second target character string. The second verification specifically includes the following steps: generating the fourth tensor based on the signature information, the fourth tensor may be represented by Bᵢ, and for i∈{1, . . . , r}, the second electronic device may use a formula Bᵢ=(Eᵢ, Eᵢ, Eᵢ)^{∘}A_{f}_{ᵢ} to generate at least one fourth tensor.

Next, based on the fourth tensor, the to-be-sent file may be digitally signed by using the hash function, to obtain the second character string. Specifically, the to-be-sent file M may be concatenated with the fourth tensors B′₁, . . . , B′ᵣ as a character string, then a hash operation may be performed on the concatenated character string to obtain the second character string, represented by H(M|B′₁| . . . |B′ᵣ).

M|B′₁| . . . |B′ᵣrepresents the character string as a result of concatenation of the to-be-sent file M and the fourth tensors B₁, . . . , Bᵣ, the second character string may be a binary character string, i.e., a character string of characters ‘0’ and ‘1’, whose length may be r*s.

Finally, the signature information may be verified based on the second character string. When the second character string is identical to the character string in the signature information, the signature information verification is successful, that is, the to-be-sent file is indeed sent by the first electronic device. When the second character string is not identical to the character string in the signature information, the signature information verification fails, that is, the to-be-sent file is sent by other electronic device than the first electronic device.

In the embodiment, the Q second target character strings are generated based on the signature information; the fourth tensor is generated based on the signature information in a case that the hash value of the root node of the hash tree is equal to each of the second target character strings; the to-be-sent file is digitally signed based on the fourth tensor, to obtain the second character string; the signature information is verified based on the second character string. In this way, when the second electronic device obtains the public key published by the first electronic device, it is very easy for the second electronic device to verify the signature information based on the public key and the received to-be-sent file and the signature information of the to-be-sent file, so as to authenticate the identity of the sender of the to-be-sent file. At the same time, the dual-verification of the signature information may further ensure accuracy of the authentication.

Optionally, the signature information includes P character strings, P is a positive integer greater than 1, and the step S305 specifically includes:

segmenting the second character string to obtain K character strings, where P is equal to K;

determining that signature information verification is successful in a case that the P character strings are equal to the K character strings in a one-to-one manner; or determining that signature information verification fails in a case that a third target character string in the P character strings is not equal to a fourth target character string in the K character strings, where a position of the third target character string in the P character strings corresponds to a position of the fourth target character string in the K character strings, the third target character string is any one character string of the P character strings.

In this implementation, the second character string may be segmented to obtain multiple character strings, for example, to obtain r character strings of characters ‘0’ and ‘1’, where each of the r character strings has a length s. The r character strings may be represented by f′₁, . . . , f′ᵣ, respectively.

For i∈{1, . . . r}, if fᵢ=f′ᵢ, signature information verification is successful, otherwise, the signature information verification fails.

In this implementation, multiple character strings are obtained by segmenting the second character string, and these multiple character strings are compared with multiple character strings in the signature information in a one-to-one manner. In a case that the multiple character strings are all identical to the multiple character strings in the signature information in a one-to-one manner, signature information verification is successful, and in a case that any difference of character strings is found, the signature information verification fails. Thus, the signature information may be verified very easily.

Optionally, the signature information includes N second tensors and an authentication path of each second tensor of the N second tensors relative to the root node of the hash tree, and the step S302 specifically includes: for each second tensor of the N second tensors, generating the second target character string corresponding to the second tensor based on the second tensor and the authentication path of the second tensor relative to the root node of the hash tree, where Q is equal to N.

In the implementation, for i∈{1, . . . , r}, based on the second tensor A_{f}_{ᵢ} and its authentication path pathᵢ, a formula pathᵢ(A_{f}_{ᵢ})=h_{0.0} is used. That is, the hash function is called repeatedly until a second target character string is obtained. In a case that the signature information is not forged, the hash value of the root node of the hash tree may be obtained based on the second tensor A_{f}_{ᵢ} and its authentication path pathᵢ. Therefore, the first verification of the signature information may be performed by determining, through comparison, whether the second target character string is equal to the hash value of the root node of the hash tree.

In this implementation, based on the second tensor in the signature information and the authentication path of the second tensor relative to the root node of the hash tree, the hash function is repeatedly called to obtain the second target character string, and the second target character string is compared with the hash value of the root node of the hash tree, so that the first verification of the signature information may be achieved.

In order to prove advantages of the digital signature method and the signature information verification method in the embodiments of the present application, the scheme in the embodiments of the present application may be compared with other schemes in terms of runtime, the public key length and the signature length, etc. The scheme in the embodiments of the present application is a tensor isomorphism-based scheme (incorporating hash tree technique) with a 2.4 GHz processor. The other schemes may include a lattice problem-based signature scheme Falcon with a 3.3 GHz processor, a tensor isomorphism-based signature scheme with a 2.4 GHz processor and a hash function-based signature scheme SPHINCS+with a 3.5 GHz processor.

The scheme in the embodiments of the present application is implemented based on the programming language Python prototype. A runtime table of the schemes is as shown in Table 2 below, and a table of the public key lengths and the signature lengths of the schemes is as shown in Table 3 below.

TABLE 2
runtime table of the schemes

| | Runtime | | |
|---|---|---|---|
| | Time for | | |
| | generating the | | |
| | public key and | Signature | verification |
| | the private key | time | time |
| Signature scheme | (seconds) | (seconds) | (seconds) |
| Tensor isomorphism | 0.155 | 0.010 | 0.007 |
| scheme (incorporating | | | |
| hash tree technique) | | | |
| with a 2.4 GHz processor | | | |
| SPHINCS+ with a | 0.202 | 3.030 | 0.0032 |
| 3.5 GHz processor | | | |
| Falcon with a | 1.020 | 0.258 | 0.003 |
| 3.3 GHz processor | | | |
| Tensor isomorphism-based | 0.150 | 0.026 | 0.023 |
| signature scheme with a | | | |
| 2.4 GHz processor | | | |

TABLE 3
table of the public key lengths and
the signature lengths of the schemes

| | Information length | |
|---|---|---|
| | Public key | Signature |
| Signature scheme | length (Bytes) | length (Bytes) |
| Tensor isomorphism scheme | 32 | 13658 |
| (incorporating hash tree technique) | | |
| with a 2.4 GHz processor | | |
| SPHINCS+ with a | 32 | 16976 |
| 3.5 GHz processor | | |
| Falcon with a 3.3 GHz processor | 897 | 618 |
| Tensor isomorphism-based | 303264 | 2122 |
| signature scheme with a | | |
| 2.4 GHz processor | | |

It may be seen from Table 2 that, compared with other schemes, the present scheme has a significant improvement in all of the runtimes. It can be seen from Table 3 that the present scheme may significantly reduce the public key length, compared with other schemes.

### Third Embodiment

As shown in FIG. 4, the present application provides a digital signature apparatus 400. The apparatus is applied to a first electronic device and includes: a first obtaining module 401, configured to obtain a to-be-sent file and a private key used by the first electronic device for digital signature, where the private key includes a first invertible matrix; a first generation module 402, configured to generate L second tensors based on the first invertible matrix and a randomly generated first tensor, where the L second tensors includes the first tensor and a tensor isomorphic to the first tensor, L is a positive integer greater than 1; a first digital signature module 403, configured to digitally sign the to-be-sent file based on a randomly generated second invertible matrix and the first tensor, to obtain a first character string; a construction module 404, configured to construct a hash value of a root node of a hash tree based on the L second tensors; a second generation module 405, configured to generate, based on the first character string, the first invertible matrix, the second invertible matrix, the L second tensors and the hash value of the root node of the hash tree, signature information provided by the first electronic device for the to-be-sent file.

Optionally, the second generation module 405 includes: a segmenting unit, configured to segment the first character string to obtain P character strings, where P is a positive integer greater than 1; a first generation unit, configured to generate a target matrix based on the P character strings, the first invertible matrix and the second invertible matrix; a selection unit, configured to select, based on the P character strings, N second tensors from the L second tensors, where N is a positive integer; a determination unit, configured to, for each second tensor of the N second tensors, determine an authentication path of the second tensor relative to the root node of the hash tree based on the hash value of the root node of the hash tree and the second tensor; where, the signature information includes the P character strings, the target matrix, the N second tensors, and the authentication path of each second tensor of the N second tensors relative to the root node of the hash tree.

Optionally, the N second tensors include a target tensor, the target tensor is any one tensor of the N second tensors, and the determination unit is specifically configured to determine, based on a hash value of a leaf node corresponding to the target tensor of the hash tree and the hash value of the root node of the hash tree, a target hash value of a node on a path from the leaf node corresponding to the target tensor to the root node of the hash tree; where, the authentication path of the target tensor relative to the root node of the hash tree includes: the target hash value, and a position, in the hash tree, of the node on the path from the leaf node corresponding to the target tensor to the root node of the hash tree.

Optionally, the first digital signature module 403 is specifically configured to generate a third tensor isomorphic to the first tensor based on the randomly generated second invertible matrix and the first tensor; digitally sign the to-be-sent file based on the third tensor, to obtain the first character string.

Optionally, the construction module 404 is specifically configured to construct a hash value of a leaf node of the hash tree based on the L second tensors and a randomly generated first target character string; construct a hash value of another node of the hash tree other than the leaf node based on the hash value of the leaf node of the hash tree and the first target character string, where the another node includes the root node of the hash tree.

Optionally the apparatus further includes: a third generation module, configured to generate a public key corresponding to the private key, where the public key includes the first target character string and the hash value of the root node of the hash tree; and a publishing module, configured to publish the public key.

The digital signature apparatus 400 provided in the present application is capable of implementing various processes in the embodiment of the digital signature method, and may achieve the same beneficial effects. To avoid repetition, details are not described herein again.

### Fourth Embodiment

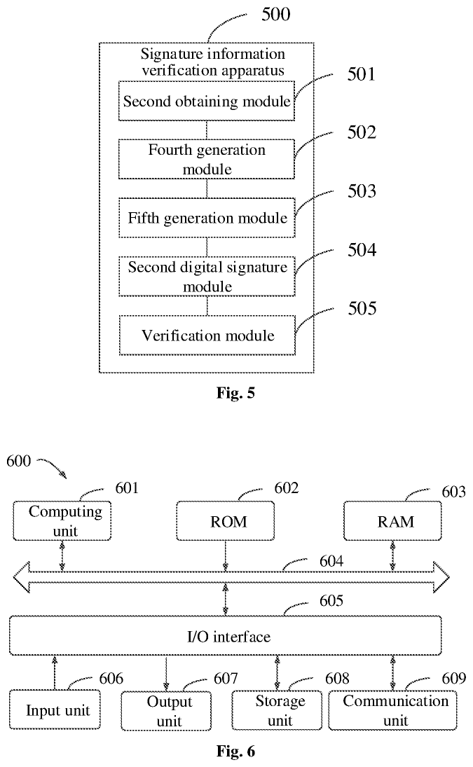

As shown in FIG. 5, the present application provides a signature information verification apparatus 500. The apparatus is applied to a second electronic device and includes: a second obtaining module 501, configured to obtain a to-be-sent file, signature information of the to-be- sent file and a public key used by the second electronic device for verifying the signature information, where the public key corresponds to a private key associated with the signature information, the public key includes a hash value of a root node of a hash tree; a fourth generation module 502, configured to generate Q second target character strings based on the signature information, where Q is a positive integer; a fifth generation module 503, configured to generate a fourth tensor based on the signature information in a case that the hash value of the root node of the hash tree is equal to each of the second target character strings; a second digital signature module 504, configured to digitally sign the to-be-sent file based on the fourth tensor, to obtain a second character string; a verification module 505, configured to verify the signature information based on the second character string.

Optionally, the signature information includes P character strings, P is a positive integer greater than 1, and the verification module 505 is specifically configured to segment the second character string to obtain K character strings, where P is equal to K; determine that signature information verification is successful in a case that the P character strings are equal to the K character strings in a one-to-one manner; or determine that signature information verification fails in a case that a third target character string in the P character strings is not equal to a fourth target character string in the K character strings, where a position of the third target character string in the P character strings corresponds to a position of the fourth target character string in the K character strings, the third target character string is any one character string of the P character strings.

Optionally, the signature information includes N second tensors and an authentication path of each second tensor of the N second tensors relative to the root node of the hash tree, and the fourth generation module 502 is specifically configured to, for each second tensor of the N second tensors, generate the second target character string corresponding to the second tensor based on the second tensor and the authentication path of the second tensor relative to the root node of the hash tree, where Q is equal to N.

The signature information verification apparatus 500 provided in the present application is capable of implementing various processes in the embodiment of the signature information verification method, and may achieve the same beneficial effects. To avoid repetition, details are not described herein again.

According to embodiments of the present application, an electronic device, a readable storage medium and a computer program product are further provided.

FIG. 6 is a schematic block diagram of an exemplary electronic device 600 for implementing embodiments of the present disclosure. The electronic device is intended to represent all kinds of digital computers, such as a laptop computer, a desktop computer, a work station, a personal digital assistant, a server, a blade server, a main frame or other suitable computers. The electronic device may also represent all kinds of mobile devices, such as a personal digital assistant, a cell phone, a smart phone, a wearable device and other similar computing devices. The components shown herein, their connections and relationships, and their functions, are meant to be exemplary only, and are not intended to limit implementation of the present disclosure described and/or claimed herein.

As shown in FIG. 6, the device 600 includes a computing unit 601 that can perform various appropriate actions and processes based on a computer program stored in a read-only memory (ROM) 602 or a computer program loaded from a storage unit 608 into a random access memory (RAM) 603. In the RAM 603, various programs and data required for the operation of the device 600 can also be stored. The computing unit 601, ROM 602, and RAM 603 are connected to each other via a bus 604. The input/output (I/O) interface 605 is also connected to the bus 604.

Multiple components in the device 600 are connected to the I/O interface 605, the components include: an input unit 606, such as a keyboard, and a mouse; an output unit 607, such as various types of displays and speakers; a storage unit 608, such as a magnetic disk and an optic disc; and a communication unit 609, such as a network card, a modem, and a wireless communication transceiver. The communication unit 609 allows the device 600 to exchange information/data with other devices via a computer network such as Internet and/or various telecommunication networks.

The computing unit 601 may be a variety of general-purpose and/or specialized processing components with processing and computing capabilities. Some examples of the computing unit 601 include, but are not limited to, a central processing unit (CPU), a graphic processing unit (GPU), various specialized artificial intelligence (AI) computing chips, various computing units running a machine learning model algorithm, a digital signal processor (DSP), and any appropriate processor, controller and microcontroller. The computing unit 601 performs various methods and processes described above, such as the digital signature method or the signature information verification method. For example, in some embodiments, the digital signature method or the signature information verification method may be implemented as a computer software program which is tangibly included in a machine-readable medium, such as the storage unit 608. In some embodiments, a part or all of the computer program may be loaded into and/or installed on the device 600 via the ROM 602 and/or the communication unit 609. When the computer program is loaded into the RAM 603 and executed by the computing unit 601, one or more steps of the digital signature method or the signature information verification method described above may be performed. Optionally, in other embodiments, the computing unit 601 may be configured by any other suitable means (e.g., with the aid of firmware) to perform the digital signature method or the signature information verification method.

Various implementations of the systems and technologies described above may be implemented in digital electronic circuit systems, integrated circuit systems, field-programmable gate arrays (FPGAs), application specific integrated circuits (ASICs), application specific standard products (ASSPs), systems-on-a-chips (SOCs), complex programmable logic devices (CPLDs), computer hardware, firmware, software, and/or combinations thereof. These various implementations may include implementation in one or more computer programs that may be executed and/or interpreted on a programmable system including at least one programmable processor. The programmable processor may be a dedicated or general purpose programmable processor, and may receive data and instructions from a storage system, at least one input device and at least one output device, and transmit the data and instructions to the storage system, the at least one input device and the at least one output device.

The program codes used to implement the methods of the present disclosure may be written in any programming language or any combination of programming languages. Such program codes may be provided to a processor or controller of a general purpose computer, special purpose computer, or other programmable data processing device, such that the program codes, when executed by the processor or controller, causes the functions/operations specified in the flowchart and/or block diagram to be implemented. Program codes may be executed completely on the machine, partially on the machine, partially on the machine and partially on a remote machine as a standalone package, or completely on a remote machine or server.

In the context of the present disclosure, a machine-readable medium may be a tangible medium, the tangible medium may include or store a program to be used by or in combination with an instruction-execution system, device, or apparatus. The machine-readable medium may be machine readable signal medium or machine readable storage medium. The machine-readable medium may include, but is not limited to, electronic, magnetic, optical, electromagnetic, infrared, or semiconductor systems, devices, or apparatus, or any suitable combination of the foregoing. More specific examples of the machine-readable storage medium include an electrical connection based on one or more wires, a portable computer disk, a hard disk, a random access memory (RAM), a read only memory (ROM), an erasable programmable read only memory (EPROM or flash memory), an optical fiber, a portable compact disk-read only memory (CD-ROM), an optical storage device, a magnetic storage device, or any suitable combination of the above.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system including a back-end component (e.g., as a data server), or a computing system including a middle-ware component (e.g., an application server), or a computing system including a front-end component (e.g., a client computer having a graphical user interface or a Web browser through which a user can interact with an implementation of the system and technique), or a computing system including any combination of such back-end, middleware, or front-end components. The components of the system can be interconnected by any form or medium of digital data communication (e.g., a communication network). Examples of a communication network include a local area network (LAN), a wide area network (WAN), the Internet and a blockchain network.

The computer system can include a client and a server. The client and server are generally remote from each other and typically interact through a communication network. The relationship of client and server arises by virtue of computer programs running on respective computers and having a client-server relationship with each other. The server may be a cloud server, also known as a cloud computing server or cloud host, which is a host product in a cloud computing service system to solve defects of hard management and weak service scalability that exist in traditional physical hosts and VPS (Virtual Private Server) services. The server may also be a server in a distributed system, or a server incorporating a blockchain.

It is appreciated, all forms of processes shown above may be used, and steps thereof may be reordered, added or deleted. For example, as long as expected results of the technical solutions of the present application can be achieved, steps set forth in the present application may be performed in parallel, performed sequentially, or performed in a different order, and there is no limitation in this regard.

The foregoing specific implementations constitute no limitation on the scope of the present application. It is appreciated by those skilled in the art, various modifications, combinations, sub-combinations and replacements may be made according to design requirements and other factors. Any modifications, equivalent replacements and improvements made without deviating from the spirit and principle of the present application shall be deemed as falling within the scope of the present application.

What is claimed is:

1. A digital signature method, applied to a first electronic device, comprising:
obtaining a to-be-sent file and a private key used by the first electronic device for digital signature, wherein the private key comprises a first invertible matrix;
generating L second tensors based on the first invertible matrix and a randomly generated first tensor, wherein the L second tensors comprise the first tensor and a tensor isomorphic to the first tensor, and L is a positive integer greater than 1;
digitally signing the to-be-sent file based on a randomly generated second invertible matrix and the first tensor to obtain a first character string;
constructing a hash value of a root node of a hash tree based on the L second tensors; and
generating signature information provided by the first electronic device for the to-be-sent file based on the first character string, the first invertible matrix, the second invertible matrix, the L second tensors and the hash value of the root node of the hash tree.

2. The digital signature method according to claim 1, wherein generating the signature information provided by the first electronic device for the to-be-sent file comprises:
segmenting the first character string to obtain P character strings, wherein P is a positive integer greater than 1;
generating a target matrix based on the P character strings, the first invertible matrix and the second invertible matrix;
selecting, based on the P character strings, N second tensors from the L second tensors, wherein N is a positive integer;
for each second tensor of the N second tensors, determining an authentication path of the second tensor relative to the root node of the hash tree based on the hash value of the root node of the hash tree and the second tensor; and
wherein the signature information comprises the P character strings, the target matrix, the N second tensors, and the authentication path of each second tensor of the N second tensors relative to the root node of the hash tree.

3. The digital signature method according to claim 2, wherein the N second tensors comprise a target tensor, wherein the target tensor is any one tensor of the N second tensors, and wherein for each second tensor of the N second tensors, determining the authentication path of the second tensor relative to the root node comprises:
determining, based on a hash value of a leaf node corresponding to the target tensor of the hash tree and the hash value of the root node of the hash tree, a target hash value of a node on a path from the leaf node corresponding to the target tensor to the root node of the hash tree;
wherein the authentication path of the target tensor relative to the root node of the hash tree comprises the target hash value and a position in the hash tree of the node on the path from the leaf node corresponding to the target tensor to the root node of the hash tree.

4. The digital signature method according to claim 1, wherein digitally signing the to-be-sent file based on the randomly generated second invertible matrix and the first tensor to obtain the first character string comprises:
generating a third tensor isomorphic to the first tensor based on the randomly generated second invertible matrix and the first tensor;
digitally signing the to-be-sent file based on the third tensor to obtain the first character string.

5. The digital signature method according to claim 1, wherein constructing the hash value of the root node of the hash tree based on the L second tensors comprises:
constructing a hash value of a leaf node of the hash tree based on the L second tensors and a randomly generated first target character string;
constructing a hash value of a further node of the hash tree other than the leaf node based on the hash value of the leaf node of the hash tree and the first target character string, wherein the further node comprises the root node of the hash tree.

6. The digital signature method according to claim 5, wherein, prior to obtaining the to-be-sent file and the private key used by the first electronic device for digital signature, the method further comprises:
generating a public key corresponding to the private key, wherein the public key comprises the first target character string and the hash value of the root node of the hash tree; and
publishing the public key.

7. A signature information verification method, applied to a second electronic device, comprising:
obtaining a to-be-sent file, signature information of the to-be-sent file, and a public key used by the second electronic device for verifying the signature information, wherein the public key corresponds to a private key associated with the signature information, and the public key comprises a hash value of a root node of a hash tree;
generating Q second target character strings based on the signature information, wherein Q is a positive integer;
generating a fourth tensor based on the signature information in a case that the hash value of the root node of the hash tree is equal to each of the second target character strings;
digitally signing the to-be-sent file based on the fourth tensor to obtain a second character string; and
verifying the signature information based on the second character string.

8. The signature information verification method according to claim 7, wherein the signature information comprises P character strings, wherein P is a positive integer greater than 1, and wherein verifying the signature information based on the second character string comprises:
segmenting the second character string to obtain K character strings, wherein P is equal to K; and
determining that signature information verification is successful in a case that the P character strings are equal to the K character strings in a one-to-one manner; or determining that signature information verification fails in a case that a third target character string in the P character strings is not equal to a fourth target character string in the K character strings, wherein a position of the third target character string in the P character strings corresponds to a position of the fourth target character string in the K character strings, and the third target character string is any one character string of the P character strings.

9. The signature information verification method according to claim 7, wherein:
the signature information comprises N second tensors and an authentication path of each second tensor of the N second tensors relative to the root node of the hash tree, and
generating the Q second target character strings based on the signature information comprises, for each second tensor of the N second tensors, generating a second target character string corresponding to the second tensor based on the second tensor and the authentication path of the second tensor relative to the root node of the hash tree, wherein Q is equal to N.

10. An electronic device, comprising:
at least one processor; and
a memory communicatively connected to the at least one processor, wherein the memory stores therein instructions executable by the at least one processor, and the instructions, when executed by the at least one processor, cause the at least one processor to implement a digital signature method, wherein the method comprises,
obtaining a to-be-sent file and a private key used by the first electronic device for digital signature, wherein the private key comprises a first invertible matrix,
generating L second tensors based on the first invertible matrix and a randomly generated first tensor, wherein the L second tensors comprises the first tensor and a tensor isomorphic to the first tensor, and L is a positive integer greater than 1,
digitally signing the to-be-sent file based on a randomly generated second invertible matrix and the first tensor to obtain a first character string,
constructing a hash value of a root node of a hash tree based on the L second tensors, and
generating signature information provided by the first electronic device for the to-be-sent file based on the first character string, the first invertible matrix, the second invertible matrix, the L second tensors and the hash value of the root node of the hash tree.

11. The electronic device according to claim 10, wherein generating the signature information provided by the first electronic device for the to-be-sent file comprises:
segmenting the first character string to obtain P character strings, wherein P is a positive integer greater than 1;
generating a target matrix based on the P character strings, the first invertible matrix and the second invertible matrix;
selecting, based on the P character strings, N second tensors from the L second tensors, wherein N is a positive integer; and
for each second tensor of the N second tensors, determining an authentication path of the second tensor relative to the root node of the hash tree based on the hash value of the root node of the hash tree and the second tensor;
wherein the signature information comprises the P character strings, the target matrix, the N second tensors, and the authentication path of each second tensor of the N second tensors relative to the root node of the hash tree.

12. The electronic device according to claim 10, wherein digitally signing the to-be-sent file based on the randomly generated second invertible matrix and the first tensor to obtain the first character string comprises:
generating a third tensor isomorphic to the first tensor based on the randomly generated second invertible matrix and the first tensor; and
digitally signing the to-be-sent file based on the third tensor to obtain the first character string.

13. The electronic device according to claim 10, wherein constructing the hash value of the root node of the hash tree based on the L second tensors comprises:
constructing a hash value of a leaf node of the hash tree based on the L second tensors and a randomly generated first target character string; and
constructing a hash value of a further node of the hash tree other than the leaf node based on the hash value of the leaf node of the hash tree and the first target character string, wherein the further node comprises the root node of the hash tree.

14. An electronic device, comprising:
at least one processor; and
a memory communicatively connected to the at least one processor, wherein the memory stores therein instructions executable by the at least one processor, and the instructions, when executed by the at least one processor, causes the at least one processor to implement the signature information verification method according to claim 7.

15. The electronic device according to claim 14, wherein the signature information comprises P character strings, P is a positive integer greater than 1, and verifying the signature information based on the second character string comprises:
segmenting the second character string to obtain K character strings, wherein P is equal to K; and
determining that signature information verification is successful in a case that the P character strings are equal to the K character strings in a one-to-one manner; or determining that signature information verification fails in a case that a third target character string in the P character strings is not equal to a fourth target character string in the K character strings, wherein a position of the third target character string in the P character strings corresponds to a position of the fourth target character string in the K character strings, and the third target character string is any one character string of the P character strings.

16. The electronic device according to claim 14, wherein:
the signature information comprises N second tensors and an authentication path of each second tensor of the N second tensors relative to the root node of the hash tree, and
generating the Q second target character strings based on the signature information comprises, for each second tensor of the N second tensors, generating a second target character string corresponding to the second tensor based on the second tensor and the authentication path of the second tensor relative to the root node of the hash tree, wherein Q is equal to N.

17. A non-transitory computer readable storage medium storing therein a computer instruction, wherein the computer instruction is configured to cause a computer to implement the digital signature method according to claim 1.

18. A non-transitory computer readable storage medium storing therein a computer instruction, wherein the computer instruction is configured to cause a computer to implement the signature information verification method according to claim 7.

19. A computer program product, wherein the computer program product, when being executed by an electronic device, causes the electronic device to implement the digital signature method according to claim 1.

20. A computer program product, wherein the computer program product, when being executed by an electronic device, causes the electronic device to implement the signature information verification method according to claim 7.
